(19) United States
(12) Patent Application Publication
(10) Pub. No.: US 2017/0202417 A1
(43) Pub. Date: Jul. 20, 2017

(54) Vacuum Cleaner Filter Bag for an Upright Vacuum Cleaner

(71) Applicant: EUROFILTERS N.V., Overpelt (BE)

(72) Inventors: Jan SCHULTINK, Overpelt (BE); Ralf SAUER, Overpelt (BE)

(73) Assignee: Eurofilters N.V., Overpelt (BE)

(21) Appl. No.: 15/302,124

(22) PCT Filed: Mar. 19, 2015
(86) PCT No.: PCT/EP2015/055797

§ 371 Date: Oct. 5, 2016

(30) Foreign Application Priority Data
Apr. 8, 2014 (EP) 14163816.3

(51) Int. Cl. A47L 9/14; B01D 46/02; A47L 5/28

(52) U.S. Cl. CPC A47L 9/1436; A47L 5/28; B01D 46/02; B01D 2275/205; B01D 2279/55

(57) ABSTRACT

The present invention relates to a vacuum cleaner filter bag for an upright vacuum cleaner. The vacuum cleaner filter bag according to the invention thereby has a greater length than width, one long side and one narrow side resulting. It is formed from two bag walls which are joined together circumferentially so that an internal space is configured between the two bag walls. One bag wall thereby has an inlet opening through which air to be cleaned can flow into the vacuum cleaner filter bag. The vacuum cleaner filter bag according to the invention is distinguished by the bag wall in which the inlet opening is introduced having folding which extends in the longitudinal direction of the vacuum cleaner filter bag, as a result of which this bag wall has increased flexibility and the vacuum cleaner filter bag opens during folding-over of the retaining plate when inserting the filter bag in a vacuum cleaner such that the air can enter essentially unimpeded into the filter bag.

The present invention relates to a vacuum cleaner filter bag for an upright vacuum cleaner. The vacuum cleaner filter bag according to the invention thereby has a greater length than width, one long side and one narrow side resulting. It is formed from two bag walls which are joined together circumferentially so that an internal space is configured between the two bag walls. One bag wall thereby has an inlet opening through which air to be cleaned can flow into the vacuum cleaner filter bag. The vacuum cleaner filter bag according to the invention is distinguished by the bag wall in which the inlet opening is introduced having folding which extends in the longitudinal direction of the vacuum cleaner filter bag, as a result of which this bag wall has increased flexibility and the vacuum cleaner filter bag opens during folding-over of the retaining plate when inserting the filter bag in a vacuum cleaner such that the air can enter essentially unimpeded into the filter bag.

Various vacuum cleaner filter bag forms are known from the state of the art. In the case of paper filter bags, block- or block base filter bags are common. In the case of filter bags made of nonwovens, such shapes can scarcely be produced from a technical manufacturing point of view. Therefore, filter bags made of nonwovens are mainly produced as flat bags. Significant efforts have been made to develop filter bags made of nonwovens with which particularly good adaptation to a bag receiving space can be ensured. Such filter bags made of nonwovens which are modelled on the known block- or block base filter bag design, from a constructional point of view, are normally termed 3D filter bags. There are understood by such 3D filter bags, filter bags which also have additional bag sides in addition to an upper side and a lower side. In cylinder-type vacuum cleaners, as are common in Europe, nonwoven filter bags are used practically exclusively as flat bags and flat bags with side folds. In the United States and Great Britain, mainly types of vacuum cleaner of the so-called upright design are used, for which mainly block base bags made of filter paper are used. Upright vacuum cleaners are distinguished by having a cleaning head in which the motor is integrated. A collecting vessel is fitted on this cleaning head, into which vessel the corresponding vacuum cleaner filter bag for the upright vacuum cleaner is inserted. The vacuum cleaner filter bags for upright vacuum cleaners are distinguished by a greater length-to-width ratio. An upright vacuum cleaner is known e.g. from EP 2 030 552 A2. With respect to the spatial dimensioning and constructional details, reference is made in particular also to the disclosure content of this patent application for the purposes of the present invention.

In particular in the case of flat bags made of nonwovens, different types of folding are known for increasing the effective filter surfaces.

Thus for example DE 20 2005 000 918 U 1 discloses a vacuum cleaner filter bag with a wall which consists of weldable flexible filter material and has folds on two opposite sides, an increase in volume of the filter bag, in the operating state of the vacuum cleaner filter bag, being achieved by turning out this folding.

A comparable vacuum cleaner filter bag in which these folds are present on all four sides is known from DE 20 2005 000 917 U1.

A development of this concept is known from WO 00764320, the vacuum cleaner filter bag presented there having a plurality of lateral folds which, in the operating state of the vacuum cleaner filter bag, are turned out and lead to an increase in bag volume.

A particularly effective increase in the vacuum cleaner filter bag volume is known from EP 2 366 321 A1. The compartment bag presented there has a large number of folds of the bag walls so that the vacuum cleaner filter bag volume and the dust storage capacity are effectively increased.

In the case of vacuum cleaner filter bags made of nonwovens for upright vacuum cleaners, a different problem is however posed in principle.

These vacuum cleaner filter bags are chosen inherently to be of a large volume so that the increase in the already enormous volume of the vacuum cleaner filter bag is not of primary importance. A flat filter bag made of nonwoven, dimensioned for the volume of the upright vacuum cleaner, can be used only in a conditional manner in an upright vacuum cleaner. Such a filter bag—according to the installation situation in the filter bag receiving space of an upright vacuum cleaner—does not unfold or only incompletely. The essential problem resides in the fact that a corresponding flat bag made of nonwoven does not completely unfold from the storage state. In addition hereto, the problem exists that, when inserting a flat filter bag in the upright vacuum cleaner, kinks in the filter bag result so that the actual geometry of the filter bag is permanently distorted. This increases the above-mentioned unfolding problem in addition, likewise the theoretical filling volume and also the homogeneous distribution of the received dust in the filter bag is consequently permanently impaired. In the case of fairly long operation, the result can hence be clogging of the vacuum cleaner filter bag which has not yet completely unfolded so that a notable reduction in volume and a loss of volume which can be filled can consequently be observed. The lifespan of such upright filter bags can consequently be significantly reduced.

The present invention therefore sets the object of further developing the special type of upright vacuum cleaner filter bags and in particular of ensuring that, even from the first operation of the vacuum cleaner filter bag, complete unfolding is made possible.

Likewise, it is the object of the present invention to indicate purposes of use of the upright vacuum cleaner filter bag according to the invention, and also to indicate a method for the production thereof.

This object is achieved, with respect to a vacuum cleaner filter bag, by the features of patent claim 1, with respect to purposes of use of the vacuum cleaner filter bag, by the features of patent claim 13 and also, with respect to a method for the production of the vacuum cleaner filter bag, by the features of patent claim 14. The respective dependent patent claims thereby represent advantageous developments.

The invention hence relates to a vacuum cleaner filter bag for an upright vacuum cleaner which has a length and a width in a ratio of >1.5 so that the vacuum cleaner filter bag has a long side and a narrow side, with a first bag wall comprising a filter material, a second bag wall comprising a filter material, the first and second bag wall being joined circumferentially at the edge so that the vacuum cleaner filter bag is completely closed and, between the first and the second bag wall, an internal space is configured, an inlet opening introduced into the first bag wall through which air to be cleaned can flow into the vacuum cleaner filter bag and also a retaining plate enclosing the inlet opening, at least the first bag wall having folding which comprises at least one first and one second side fold and extends in the longitudinal direction of the vacuum cleaner filter bag, the first and second side fold extending parallel or substantially parallel to each other, the first side fold having two legs and the length ratio of leg to leg being of 0.1 to 0.8.

As a result of the length-to-width ratio of >1.5, the vacuum cleaner filter bag has a long side and a narrow side. The first bag wall of the vacuum cleaner filter bag thereby has both the folding and the retaining plate together with inlet opening. As a result of the folding present according to the invention on the first bag wall, the first bag wall has an increased surface, compared with the surface formed by the outlines of the filter bag. The folding is thereby bonded in the fixing which extends around the two bag walls at the edge, i.e. the legs situated one above the other are hereby joined together in the fixing. In the bag wall itself, the folding is however present in a loose and flexible manner. If now a vacuum cleaner filter bag according to the invention is inserted in the filter space of the upright vacuum cleaner provided for this purpose, the discharge connection piece of the upright vacuum cleaner is introduced into the inlet opening of the vacuum cleaner filter bag and fixes the retaining plate on a fixing device present in the upright vacuum cleaner. The retaining plate must hereby be moved from the storage position thereof, for example tilted by 90°. Because of the fact that, as a result of the folding in the first bag wall, more filter material is available, compared with the above-described nominal area defined by the outlines, sufficient clearance is present for such a movement of the retaining plate for fixing and holding the vacuum cleaner filter bag in the upright vacuum cleaner. At the same time, pulling-up of the folding and asymmetrical deformation of the upright vacuum cleaner filter bag is thereby effected, as a result of which, even when introducing the vacuum cleaner filter bag into the upright vacuum cleaner, complete unfolding takes place. A first unfolding of the vacuum cleaner filter bag is hence effected already before the first operation of the vacuum cleaner filter bag which is used and the initially described problem of the possibly incomplete unfolding of the vacuum cleaner filter bag is hence effectively prevented. Even during insertion, it can hence be ensured that the vacuum cleaner filter bag is present in the upright vacuum cleaner completely unfolded.

Each fold, as the concept is used in the context of the present invention, comprises two fold legs and a fold hinge. There is understood by a fold hinge, the point of a fold with the smallest radius of curvature. As a result of the intended joining of the fold hinges, a so-called fold axis is obtained. The fold axis is also termed fold back. The fold axis can correspond to the longitudinal axis of a fold. The region of a fold with a radius of curvature which is greater than the minimum radius of curvature of the fold is termed fold leg. The region situated between the fold legs of a fold is termed fold core. The fold legs of a fold can therefore have in particular also a curvature. Folds can also have turning points. Turning points are those places of a fold, in particular of the fold legs, at which the curvature of the fold changes from concave to convex. A joining line which joins a plurality of turning points of a fold is termed inflection line (turning line). Two adjacent folds can also separate one fold leg. The sequence of a plurality of folds, in the context of the present invention, is termed folding. Folds can have in particular legs which extend parallel to the bag wall. The fold legs of the folds can in particular be smooth. There is hereby understood by “smooth”, that the fold legs have no compressions and/or structuring, in particular which are intended to stabilise the form of the folds. One or more fold legs of one or more folds can comprise one or more embossed structures, in particular the embossed structures not serving for stabilisation of the form of the folds. As a result, a further increase in the surface available for the filtration can possibly be achieved.

It is now essential in the invention that the leg of the first fold which is formed by the portion of the wall which extends from the lateral joining edge of the vacuum cleaner filter bag up to the first fold is longer than the second leg of the first fold, i.e. the leg which is formed by joining the first and second fold and hence is common to the first and second fold. It is hence ensured that the first fold, but also the second fold, are disposed in the region between the two lateral joining lines of the first and second wall of the vacuum cleaner filter bag in the longitudinal direction. As a result, optimum unfolding is ensured when inserting the vacuum cleaner filter bag into the upright vacuum cleaner.

As a result of the arrangement or dimensioning according to the invention of the respective legs of the first fold, the folding is configured lying in the vacuum cleaner filter bag according to the invention. There is understood by this that the fold legs of the folding are disposed essentially parallel to the bag wall and situated lying one above the other.

The retaining plate is hereby regarded in general as an element of the vacuum cleaner filter bag which serves for mounting the vacuum cleaner filter bag in the interior of a vacuum cleaner housing. The retaining plate can be joined in particular to the bag wall of the vacuum cleaner filter bag and be disposed in the region of an inflow opening. It can be advantageous to seal the bag wall which has the folding, in a first step, for example by ultrasonic welding and, in a second step, to weld on the retaining plate. For mounting the vacuum cleaner filter bag in a vacuum cleaner, the retaining plate is joined to a corresponding mounting element of the vacuum cleaner, in particular brought into engagement. The retaining plate can basically have any form. For example, the retaining plate can be configured as a flat, planar component, as shown in EP 1 849 392. The retaining plate can also have a more complex structure, as shown for instance in DE 20 2008 006 604.

According to a preferred embodiment, the retaining plate with the inlet opening is disposed close to a narrow-side edge (i.e. a narrow side) of the vacuum cleaner filter bag. The retaining plate is thereby accommodated in the first bag wall over the entire surface, i.e. the retaining plate projects, at no point, beyond the dimensioning of the vacuum cleaner bag which seals the filter bag and is produced by the circumferential join. The ratio of the minimum spacing of the retaining plate to a narrow-side join of the vacuum cleaner filter bag, relative to a dimensioning of the retaining plate in the longitudinal direction of the vacuum cleaner filter bag, is hereby preferably <0.5, preferably <0.2, particularly preferably of 0.1 to 0.

Alternatively and likewise preferred is that the retaining plate with inlet opening is disposed in the first wall of the vacuum cleaner filter bag such that the retaining plate protrudes beyond the narrow side of the vacuum cleaner filter bag or overlaps at this narrow side. It should however be taken into account hereby that the projection must be dimensioned such that the inlet opening is still configured in the wall over the entire surface. Preferably, the ratio of the projection of the retaining plate relative to a narrow-side join of the vacuum cleaner filter bag, to a dimensioning of the retaining plate in the longitudinal direction of the vacuum cleaner filter bag, is <0.5, preferably <0.2, particularly preferably of 0.1 to 0.01.

In the case of these embodiments, it is preferred furthermore if the retaining plate is configured in the region of a fold leg over the entire surface, i.e. no side fold is present in the region of the fitting site of the retaining plate.

Both previously described, preferred embodiments enable an excellent type of unfolding of the vacuum cleaner filter bag according to the invention during insertion in an upright vacuum cleaner provided for this purpose. By means of the fitting of the retaining plate as close to the edge as possible, the vacuum cleaner filter bag, at this end, need be only insubstantially curved or distorted by moving the retaining plate. At the same time, in addition a complete unfolding, i.e. the interior is covered by spreading apart the first from the second bag wall, is consequently ensured.

Furthermore, it is preferred that the folding of the first bag wall of the filter material has at most eight, preferably at most four, side folds.

In particular and particularly preferred according to the invention, at least the folding of the first bag wall has four side folds, the folding being configured preferably symmetrically with respect to the first bag wall.

This embodiment can provide for example that the first bag wall of the vacuum cleaner filter bag has merely four folds, which is configured according to the previously described general embodiments. The four side folds are thereby applied at least in the first wall of the vacuum cleaner filter bag. The symmetry is thereby in mirror image with respect to an accordingly centrally extending longitudinal axis of the vacuum cleaner filter bag so that the first fold is configured mirror-symmetrically to the third fold and the second fold mirror-symmetrically to the fourth fold. The folding hence comprises a leg which joins the second and fourth fold and forms the front-side of the wall of the vacuum cleaner filter bag. Preferably, the retaining plate together with inlet opening is accommodated in particular in this leg which joins the second and fourth fold.

A preferred development of this embodiment provides that the leg joining the first and second fold is disposed on the side of the leg which is orientated away from the interior and joins the edge-side join of the long side and the first fold and, in a storage state, is situated on the latter. At the same time, the third side fold has two legs, the first leg of the third side fold joining the other edge-side join of the long side and the third fold and the second leg joining the third and fourth fold, the leg being disposed on the side of the leg orientated away from the interior and being situated on the latter in a storage state.

As already described previously, the retaining plate with the inlet opening is disposed preferably on the leg joining the second side fold and a fourth side fold.

Furthermore, it is advantageous in the case of the previously mentioned embodiment if the leg joining the second and fourth side fold is dimensioned to be at least as wide as the width of the retaining plate. Preferably, the width of the leg joining the second and fourth side fold has 1.1 to 5 times the width of the retaining plate.

An alternative embodiment of the vacuum cleaner filter bag according to the invention provides that at least the folding of the first bag wall has eight side folds, the folding being configured symmetrically with respect to the first bag wall.

This embodiment is similar to the previously described preferred embodiment with four folds, the only difference thereby is that two further folds are present in the wall. Hence the flexibility of the vacuum cleaner filter bag can be further increased.

In this embodiment, it is preferred that the folding is configured such that the respective legs of the respective side folds are situated one upon the other in the storage state and the retaining plate is disposed on an outermost leg which is dimensioned preferably to be at least as wide as the width of the retaining plate, the width of the leg having, further preferably, 1.1 to 5 times the width of the retaining plate 6.

In the case of all the previously described embodiments of the vacuum cleaner filter bag according to the invention, it is advantageous if the ratio of length to width is greater than 2, preferably greater than 3.

In principle, also the second bag wall, i.e. the bag wall situated opposite the first bag wall with retaining plate and inlet opening, can likewise have folding. In this case, the folding in the second wall can have an identical configuration to the first wall. However, it is hereby preferred that the second bag wall has no folding.

In particular, the filter material of the first and second bag wall is a nonwoven material.

The nonwoven material can comprise one or more layers made of nonwoven material. A plurality of layers of nonwoven material can be folded together in particular. The bag wall can comprise, in particular, also a laminate made of a plurality of layers, in particular two or more layers, or consist of such. For example, the laminate can be a filament spunbonded nonwoven (spunbond)—meltspun microfibre spunbonded nonwoven (meltblown nonwoven)—filament spunbonded nonwoven (spunbond) laminate (SMS laminate). Also two or more meltblown nonwoven layers can be used (SMMS laminate, SnxMS laminate).

As materials for the bag wall, in particular for the folded nonwoven material, in principle all materials known for the production of vacuum cleaner filter bags can be considered. As nonwoven material, a dry- or wet-laid nonwoven or an extrusion nonwoven, in particular a meltspun microfibre spunbonded nonwoven (meltblown nonwoven) or filament spunbonded nonwoven (spunbond) can be used. Also nanofibre layers can be present in addition. The differentiation between wet-laid nonwovens or nonwovens and conventional wet-laid paper is effected according to the definition given below, as is also used by the International Association Serving the Nonwovens and related Industries (EDANA). A conventionally known (filter-) paper is therefore not a nonwoven. The nonwoven can comprise staple fibres or endless fibres. From a technical manufacturing point of view, also a plurality of layers of staple fibres or endless fibres can be provided, which are compacted to form precisely one layer of nonwoven. For example the bag wall, in particular the folded nonwoven material, can comprise a laminate made of filament spunbonded nonwoven and meltblown nonwoven (SMS, SMMS or SnxMS). This laminate can be laminated or calendered by means of a hot adhesive. The layer made of meltblown nonwoven can be crimped. The term “nonwoven” is used according to the definition according to ISO standard ISO 9092:1988 or CEN standard EN29092. In particular, the terms fibre fleece or fleece and nonwoven are differentiated from each other in the field of production of nonwovens as follows and should be understood such also in the sense of the present invention. For the production of a nonwoven, fibres and/or filaments are used. The loose and still unbonded fibres and/or filaments are termed fleece or fibre fleece (web). By means of a so-called fleece bonding step, a nonwoven is finally produced from such a fibre fleece and has sufficient strength in order to be wound up to form rolls for example. In other words, a nonwoven is configured to be self-supporting as a result of the compaction. (Details relating to the use of the definitions and/or methods described herein can be also taken from the standard work “Nonwovens”, W. Albrecht, H. Fuchs, W. Kittelmann, Wiley-VCH, 2000). The nonwoven material (before the folds are introduced) can have, for vacuum cleaner filter bags for household use, a basis weight of below 350 g/m², preferably below 250 g/m², further preferably below 200 g/m², in particular between 25 g/m² and 150 g/m². The nonwoven material (before the folds are introduced) can also have a basis weight of over 250 g/m². In particular for commercial vacuum cleaner filter bags, this can be advantageous, according to the mechanical requirement.

Additionally or alternatively to the described developments, the vacuum cleaner filter bag can comprise at least one element for flow deflection or flow distribution in the vacuum cleaner filter bag, in particular the element being able to move in the air flow of the air flowing into the vacuum cleaner filter bag. Such an element is known for example from EP 1 787 560 or from EP 1 804 635. For example, such an element can be configured in the form of at least one material strip which is fitted in the interior of the vacuum cleaner filter bag on the bag wall or can comprise such a material strip. For example, such an element can correspond to at least one material strip made of nonwoven or filter paper or can comprise at least one material strip made of nonwoven or filter paper. The at least one material strip can be slotted at least partially.

In addition, the present invention relates to the use of a previously described vacuum cleaner filter bag according to the invention as vacuum cleaner filter bag for an upright vacuum cleaner.

Furthermore, the present invention relates to a method for the production of a previously described vacuum cleaner filter bag according to the invention for upright vacuum cleaners, in which

a web of a filter material is provided for a first bag wall and also a web of a filter material for a second bag wall, the web of filter material for the first bag wall being dimensioned to be wider than the web of filter material for the second bag wall,

in at least the web of filter material for the first bag wall, folding comprising at least one first and one second side fold is introduced so that the side folds extend parallel or substantially parallel to each other, two legs being produced,

the web of filter material for the first bag wall and also the web of filter material for a second bag wall are placed one above the other and joined circumferentially at the edge so that a completely closed vacuum cleaner filter bag is produced, which bag has an internal space configured between the first and the second bag wall so that the length ratio of the leg joining the first and second side fold to the leg which joins the edge-side join to the first side fold, is of 0.1 to 0.8, an inlet opening and also a retaining plate is introduced into the web of filter material for the first bag wall,

the web of filter material for the second bag wall having a width B and the web of filter material for the first bag wall and the web of filter material for the second bag wall having a length in a ratio of >1.5 or a corresponding ratio being set by the joining step c), step d) being able to be implemented also before step a), step b) or step c).

In the case of the method according to the invention, in principle two webs made of a filter material are hence welded together circumferentially. Preferably, simultaneously when the web for the first wall and the second wall of the vacuum cleaner filter bag are placed one above the other, folding is introduced into at least the first wall, preferably merely into the first wall, and subsequently the webs are joined together, e.g. welded, to form the finished vacuum cleaner filter bag.

It is hereby advantageous if the web of filter material for the first bag wall is dimensioned to be wider by at least 20%, preferably at least 30%, particularly preferably at least 40%, than the web of filter material for the second bag wall.

The method can be implemented in particular continuously, the web of filter material for the first bag wall and the web of filter material for the second bag wall are hereby dimensioned endlessly in the longitudinal direction and the ratio of length L to width B is produced by introducing the edge-side join in the longitudinal direction, whereupopn an individual vacuum cleaner filter bag is cut to length.

In addition, it is advantageous if the filter material for the first and second bag wall is a nonwoven material and the edge-side join is produced by welding, in particular by ultrasonic welding.

The present invention is described in more detail with reference to the subsequent embodiments without restricting the invention to the illustrated special details.

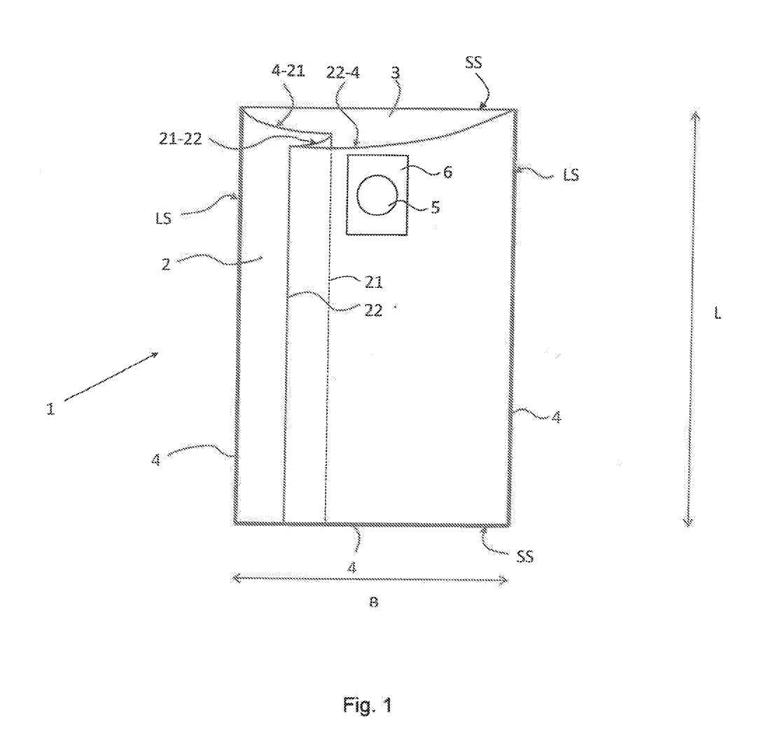

FIG. 1 hereby shows a first, basic embodiment of the present invention.

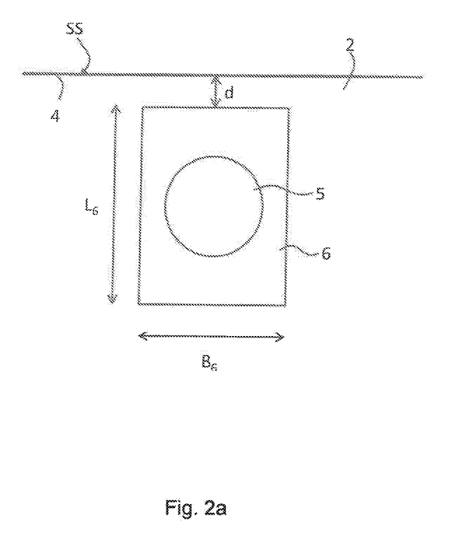

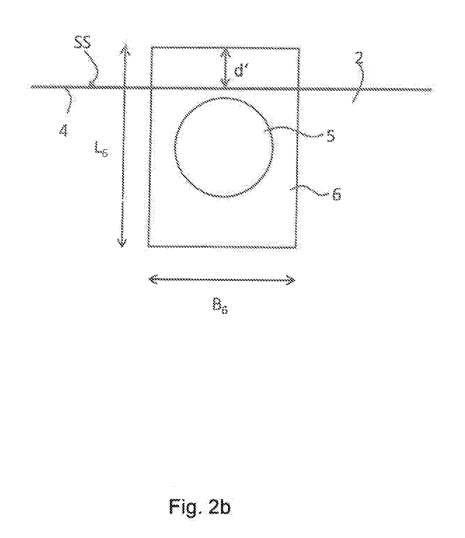

FIGS. 2a and 2b show possible positions of the retaining plate on the vacuum cleaner filter bag.

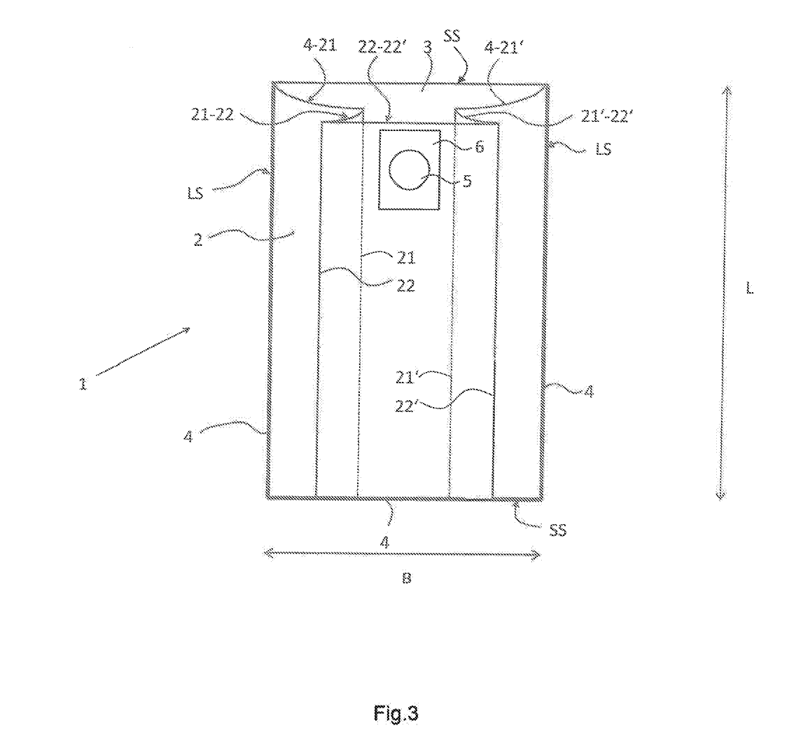

FIG. 3 shows a preferred embodiment of the present invention.

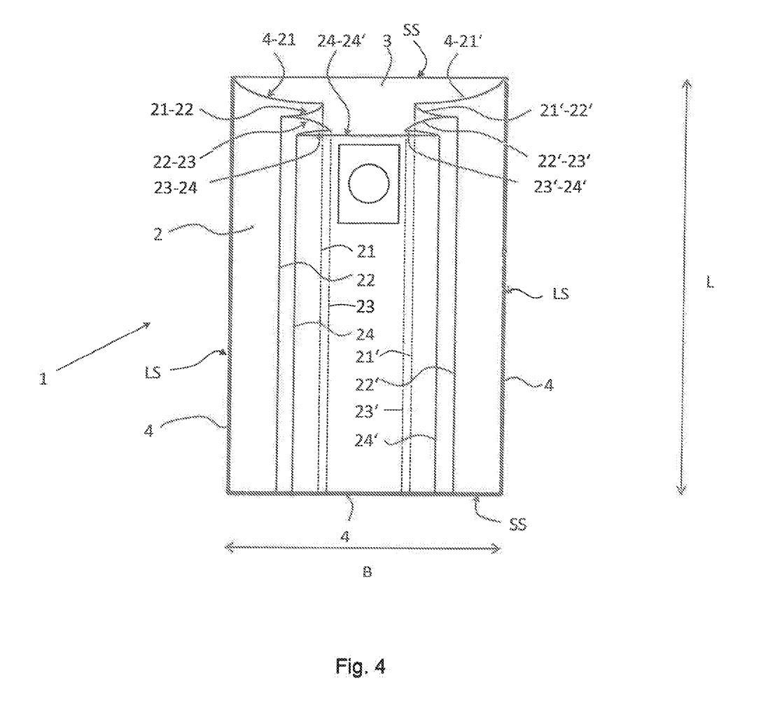

FIG. 4 shows a further embodiment of the present invention.

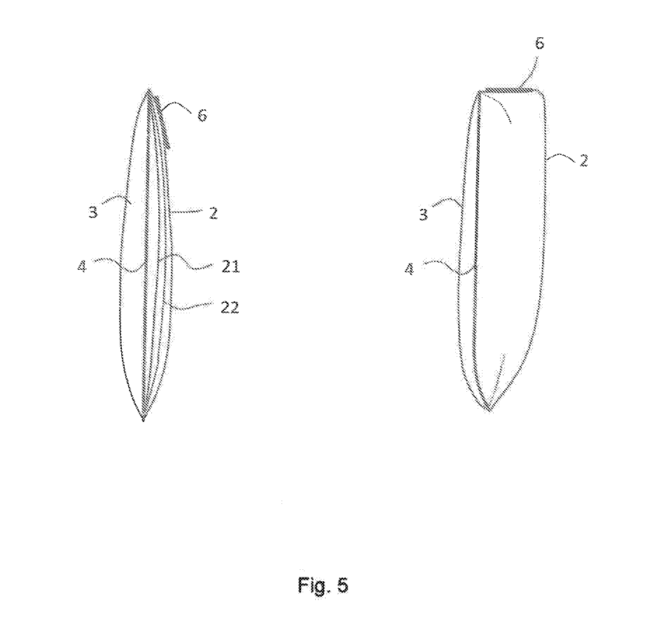

FIG. 5 clarifies the principle of the mechanical unfolding of the vacuum cleaner filter bag from a storage position into an operating state.

FIG. 1 shows a first embodiment of a vacuum cleaner filter bag 1 according to the invention. This has two long sides LS and two narrow sides SS, the lower narrow side SS illustrated in FIG. 1 being illustrated closed and, for clarification of the folding in the vacuum cleaner filter bag, the upper narrow side S being illustrated opened. In the finally manufactured state, the above-situated narrow side SS is however of course closed just as the lower-situated narrow side SS. The vacuum cleaner filter bag 1 according to the present invention comprises a first bag wall 2 and also a second bag wall 3, the first bag wall 2 in FIG. 1 being illustrated, in the present case, situated at the front. The length of the vacuum cleaner filter bag is indicated with L, the width with B. The two bag walls 2 and 3 are joined circumferentially, which is illustrated in FIG. 1 with the reference number 4. For example in the case of nonwoven materials which can be used as bag wall 2 or 3, the join 4 can be a weld seam. The first bag wall 2 comprises in addition an inlet opening 4, and also a retaining plate 6, with the retaining plate 6 the vacuum cleaner filter bag 1 can be fixed in an upright vacuum cleaner. In addition, the first bag wall 2 has folding which comprises a first side fold 21 and also a second side fold 22. The folding of the wall hence extends in the longitudinal direction L of the vacuum cleaner filter bag 1 and is configured over the entire length of the wall 2. The first fold thereby comprises two legs, namely a first leg 4-21 which is guided from the left join 4 of the vacuum cleaner filter bag to the first fold 21, and also a second leg 21-22 which joins the first fold 21 to the second fold 22. The second leg 21-22 of the first fold 21 represents, at the same time, the first leg of the second fold 22, in this respect the leg 21-22 is common to both folds 21 and 22. The second leg 22-4 of the second fold 22 leads from the second fold 22 towards the right join 4 of the vacuum cleaner filter bag.

FIG. 2a shows a first possibility for fitting a retaining plate 6 to the inlet opening 5 in the first wall 2 of the vacuum cleaner filter bag. FIG. 2a illustrates in this respect an enlarged section of the fitting region of the retaining plate 6 on the front wall 2 of the vacuum cleaner filter bag. The retaining plate thereby has a length L₆ and also a width B₆. The smallest spacing of the retaining plate 6 relative to the edge-side join 4 of the narrow side SS is thereby designated with d. According to this embodiment, it is provided that a certain spacing of the retaining plate relative to the edge-side join is not exceeded so that the retaining plate is disposed thereby as far as possible at the edge on the vacuum cleaner filter bag in order to enable uncomplicated mechanical unfolding during insertion of the vacuum cleaner filter bag into an upright vacuum cleaner. Details of the mechanical unfolding during insertion of the vacuum cleaner filter bag 1 into the upright vacuum cleaner are explained subsequently in even more detail.

FIG. 2b showed a further possibility for fitting the retaining plate on the vacuum cleaner filter bag. The retaining plate 6 hereby protrudes beyond the vacuum cleaner filter bag, i.e. is guided out over the join 4 of the above-situated narrow side SS of the vacuum cleaner filter bag. It must thereby be taken into account that the inlet opening 5 is still introduced completely into the first wall 2 of the vacuum cleaner filter bag. All the reference numbers, which were used also for FIG. 2a, apply without restriction for FIG. 2b. The projection of the retaining plate 6 is hereby the length of the greatest projecting path, measured from the point of the retaining plate 6 which is furthest removed from the join to the narrow side SS. In FIG. 2b, this stretch is characterised with d′.

FIG. 3 shows a particularly preferred embodiment of the vacuum cleaner filter bag 1 according to the invention. This is in principle configured similarly to the vacuum cleaner filter bag 1 according to FIG. 1. However, the vacuum cleaner filter bag 1 has a third fold 21′ and also a fourth fold 22′ and is configured, with respect to the folding, mirror-symmetrically to an imaginary, centrally extending longitudinal axis in longitudinal direction L of the vacuum cleaner filter bag. The second and fourth fold thereby joins a common leg 22-22′, the fourth fold and the third fold have a common leg 21′-22′ whilst the third fold is joined via a further leg 4-21′ to the right-hand, edge-side join illustrated in FIG. 3. The retaining plate 6 is thereby accommodated in the leg 22-22′ which joins the second fold 22 to the fourth fold 22′.

A further possibility for configuration of folding in the vacuum cleaner filter bag is illustrated in FIG. 4. Instead of the four explicitly present folds of the vacuum cleaner filter bag, as illustrated in FIG. 3, the vacuum cleaner filter bag illustrated in FIG. 4 has in total 8 folds which are characterised with 21, 22, 23, 24, 21′, 22′, 23′, 24′. The vacuum cleaner filter bag according to FIG. 4 is likewise configured mirror-symmetrically with respect to a centrally extending longitudinal axis in longitudinal direction L of the vacuum cleaner filter bag 1. The folds, amongst each other, thereby have common legs. The retaining plate is disposed for example in legs 24-24′ joining the fold 24 and the fold 24′.

In FIG. 5, the mode of operation of the mechanical unfolding of the vacuum cleaner filter bag during insertion into an upright vacuum cleaner is illustrated. The illustration illustrated on the left in FIG. 5 shows a vacuum cleaner filter bag according to the invention as illustrated for example in FIG. 1 or FIG. 3 in the storage state. The plan view on the left-hand longitudinal side LS of the vacuum cleaner filter bag illustrated in FIG. 1 or FIG. 3 is illustrated. The rear wall of the vacuum cleaner filter bag 3 in which no fold is introduced is detectable, and also the front wall of the vacuum cleaner filter bag in which the retaining plate and also the folding with the side folds 21 and 22 are introduced situated at the top. In FIG. 5, the vacuum cleaner filter bag is represented in the position of use, i.e. mechanically unfolded, on the right-hand side. The retaining plate is hereby pivoted upwards by approx. 90° so that a discharge connection piece of a corresponding upright vacuum cleaner (not illustrated) can be introduced through the inlet opening (not illustrated) into the interior volume of the vacuum cleaner filter bag. By means of the folding which is present, consisting of side folds 21 and 22, the first wall 2 of the vacuum cleaner filter bag has a certain flexibility so that, when folding up the retaining flap 6 in the operating position of the vacuum cleaner filter bag, the wall 2 together with the retaining plate 6 are pulled upwards. Unfolding of the folding, hence turning out of the vacuum cleaner filter bag, hereby takes place so that the front wall 2 is detached from the rear wall 3 and the vacuum cleaner filter bag is entirely opened up. A flexible deformation of the vacuum cleaner filter bag possibly thereby takes place in the upper and lower region so that, compared with the storage position, the length L of the vacuum cleaner filter bag in the operating state finishes up being somewhat shorter. The vacuum cleaner filter bag is hence already completely unfolded before the first operation so that clogging etc. can be effectively prevented.

1. A vacuum cleaner filter bag for an upright vacuum cleaner which has a length (L) and a width (B) in a ratio of >1.5 so that the vacuum cleaner filter bag has a long side (LS) and a narrow side (SS), with a first bag wall comprising a filter material, a second bag wall comprising a filter material, the first and second bag wall being joined circumferentially an edge so that the vacuum cleaner filter bag is completely closed and, between the first and the second bag wall, an internal space is configured, an inlet opening introduced into the first bag wall through which air to be cleaned can flow into the vacuum cleaner filter bag and also a retaining plate enclosing the inlet opening,
wherein at least the first bag wall has folding which comprises at least one first and one second side fold and extends in the longitudinal direction (L) of the vacuum cleaner filter bag, the first and second side fold extending parallel or substantially parallel to each other, the first side fold having two legs comprising a first leg and a second leg and a length ratio of the first leg to the second leg is 0.1 to 0.8.

2. The vacuum cleaner filter bag according to claim 1, wherein the retaining plate with the inlet opening
is disposed close to the narrow side (SS) of the vacuum cleaner filter bag, so that a ratio of a minimum spacing (d) of the retaining plate to a narrow-side join of the vacuum cleaner filter bag, relative to a dimensioning (L6) of the retaining plate in a longitudinal direction (L) of the vacuum cleaner filter bag (1), is <0.5, or
the narrow side (SS) of the vacuum cleaner filter bag is disposed projecting, so that a ratio of a projection (d′) of the retaining plate to the narrow-side join of the vacuum cleaner filter bag, relative to the dimensioning (L6) of the retaining plate in the longitudinal direction (L) of the vacuum cleaner filter bag, is <0.5.

3. The vacuum cleaner filter bag according to claim 1, wherein the folding of the first bag wall of the filter material has at most eight.

4. The vacuum cleaner filter bag according to claim 1, wherein at least the folding of the first bag wall has four side folds, the folding being configured symmetrically with respect to the first bag wall.

5. The vacuum cleaner filter bag according to claim 1, wherein the first leg is disposed on the side of the second leg which is orientated away from an interior and, in a storage state, is situated on the latter and a third side fold has two legs comprising a third leg and a fourth leg, the third leg being disposed on the side of the fourth leg orientated away from the interior and being situated on the latter in a storage state.

6. The vacuum cleaner filter bag according to claim 4, wherein the retaining plate with the inlet opening is disposed on a leg joining the second side fold and a fourth side fold.

7. The vacuum cleaner filter bag according to, claim 6, wherein the leg is dimensioned to be at least as wide as a width (B6) of the retaining plate.

8. The vacuum cleaner filter bag according to claim 1, wherein at least the folding of the first bag wall has eight side folds, the folding being configured preferably symmetrically with respect to the first bag wall.

9. The vacuum cleaner filter bag according to claim 8, wherein the folding is configured such that the respective legs of the respective side folds are situated one upon the other in the storage state and the retaining plate is disposed on an outermost leg which is dimensioned preferably to be at least as wide as the width of the retaining plate.

10. The vacuum cleaner filter bag according to claim 1, wherein a ratio of length (L) to width (B) is greater than 2.

11. The vacuum cleaner filter bag according to claim 1 wherein the second bag wall has no folding.

12. The vacuum cleaner filter bag according to claim 1, wherein the filter material of the first and second bag wall is a nonwoven material.

13. canceled.

14. A method for the production of a vacuum cleaner filter bag according to claim 1, the method comprising:
a) providing a web of a filter material for a first bag wall and also a web of a filter material for a second bag wall, the web of filter material for the first bag wall being dimensioned to be wider than the web of filter material for the second bag wall,
b) introducing in at least the web of filter material for the first bag wall, folding comprising at least one first and one second side fold so that the side folds extend parallel or substantially parallel to each other, two legs comprising a first leg and a second leg being produced,
c) placing the web of filter material for the first bag wall and also the web of filter material for the second bag wall one above the other and joined circumferentially at an edge so that a completely closed vacuum cleaner filter bag is produced, which bag has an internal space configured between the first and the second bag wall so that a length ratio of the first leg to second the leg is 0.1 to 0.8, and
d) introducing an inlet opening and also a retaining plate into the web of filter material for the first bag wall,
the web of filter material for the second bag wall having a width (B) and the web of filter material for the first bag wall and the web of filter material for the second bag wall having a length (L) in a ratio of >1.5 or a corresponding ratio being set by the joining step c).

15. The method according to claim 14, wherein the web of filter material for the first bag wall is dimensioned to be wider by at least 20%, than the web of filter material for the second bag wall.

16. The method according to claim 14, wherein the web of filter material for the first bag wall and the web of filter material for the second bag wall are dimensioned endlessly in a longitudinal direction and a ratio of length (L) to width (B) is produced by introducing the edge-side join in the longitudinal direction, whereupon an individual vacuum cleaner filter bag is cut to length.

17. The method according to claim 14, wherein the filter material for the first and second bag wall is a nonwoven material and a edge-side join is produced by welding.

18. The method according to claim 14, wherein step d) is implemented before step a), step b) or step c).

19. The vacuum cleaner filter bag according to claim 3, wherein the folding of the first bag wall of the filter material has at most four side folds.

20. The vacuum cleaner filter bag according to claim 7, wherein the width of the leg has 1.1 to 5 times the width (B6) of the retaining plate.

21. The vacuum clearner filter bag according to claim 10, wherein the ratio of length (L) to width (B) is greater than 3.
